(19) United States
(12) Patent Application Publication
(10) Pub. No.: US 2003/0174998 A1
(43) Pub. Date: Sep. 18, 2003

(54) Assembly for stacking optical fibers in an aligned two dimensional array

(76) Inventor: George Shevchuk, Old Bridge, NJ (US)

Correspondence Address: LOWENSTEIN SANDLER PC, 65 LIVINGSTON AVENUE, ROSELAND, NJ, 07068, US

(21) Appl. No.: 10/098,943

(22) Filed: Mar. 15, 2002

(51) Int. Cl. G02B 6/00; G02B 6/36

(52) U.S. Cl. 385/137; 385/83

(57) ABSTRACT

In accordance with the invention, an assembly for stacking optical fibers in a two dimensional array comprises a plurality of ferrule plates, each plate having a pair of sides. One side of the plate has a plurality of grooves for receiving the fibers, and the other side is flat. Fibers having terminated ends are disposed in the grooves with their ends aligned in a substantially planar two-dimensional array. The plates are aligned and stacked to hold the individual fibers between a groove on one plate and the flat surface of an adjacent plate. Alignment features, such as holes and pins, can facilitate plate alignment. The plates and fibers are secured in aligned position as by epoxy bonding. The assembly disclosed here is especially advantageous for mass termination of fiber optic cables and for interfacing to active devices.

### FIELD OF THE INVENTION

The present invention relates to an assembly for stacking optical fibers with their ends in an aligned two-dimensional array. The stackup assembly is particularly well suited to the mass termination of optical fiber cables, fiber bundles or optical fiber ribbons. The inventive assembly can be implemented as a termination block or as a connector.

### BACKGROUND OF THE INVENTION

Assemblies for arranging optical fibers with their ends in precisely aligned arrays have become increasingly important in optical fiber communication systems. High capacity bundles and ribbons carry numerous small fibers with tiny light-guiding cores that must be precisely aligned for interconnection with transmitters, receivers, other fibers or optical processing devices. The fibers to be aligned can be individual fibers, bundled fibers or fibers from ribbons. The ends are typically stripped of protective polymer and cleaved for insertion into the assembly. The assembly protects the fragile exposed ends, provides strain relief and provides ferrules to facilitate alignment.

Such assemblies are typically in the form of termination blocks or connectors. Termination blocks are generally used for permanent interconnection. Connectors are similar assemblies with the added feature of removability from the device into which the connector is inserted.

Ferrules for facilitating alignment have taken a variety of forms. Traditionally they were hollow metal cylinders that forced like-diameter or even unequal diameter fibers into axial alignment for minimum loss of transmitted light.

In terminating arrays of rows of optical fibers, it is cost and time prohibitive to align each fiber with its mating optical connection by a single ferrule. Thus techniques have been developed to mass terminate optical fibers, including techniques of stacking, generally referred to as “stackup”.

U.S. Pat. No. 5,620,634, entitled METHOD OF MAKING FIBER WAVEGUIDE CONNECTORS, discloses a typical prior art array of V groove plates facing one another. The '634 patent offered the use of alignment pins during a precision molding process. U.S. Pat. No. 5,519,798, entitled OPTICAL FIBER CONNECTOR INCLUDING V-GROOVED/PIN ALIGNMENT MEANS, described pins and spring clip to achieve alignment with a single layer of V groove plates facing one another. Pins and spring clips are also the method of alignment in U.S. Pat. No. 4,818,058, entitled OPTICAL CONNECTOR. And, pins combined with a compensation method for “the inherent shrinkage of plastic” were used in a similar prior art structure in U.S. Pat. No. 5,603,870, entitled OPTICAL FIBER CONNECTOR TECHNIQUES.

These methods incorporate registration devices, generally made of a stiff substrate material such as silicon or ceramic, that encase the rows of fibers in “V” shaped serrated structures on two sides of each fiber (“above” and “below” the fiber). Some of these termination devices have been made of plastic materials through molding processes. Unfortunately it has proven very difficult to achieve precision matching of the molded V grooves for holding individual fibers on both sides, particularly in the case of a multiple layer stackup. This difficulty is due to the problem of achieving registration of the two mold surfaces that stamp the two sides of a plate with grooves. Typically in a production environment, the surface stamping of one side loses the required precision of registration with respect to the surface stamping of the other side. While some of the arrangements have achieved reasonable reliability, none have been well suited to low cost mass manufacture.

### SUMMARY OF THE INVENTION

In accordance with the invention, an assembly for stacking optical fibers in a two dimensional array comprises a plurality of ferrule plates, each plate having a pair of sides. One side of the plate has a plurality of grooves for receiving the fibers, and the other side is flat. Fibers having terminated ends are disposed in the grooves. The plates are aligned and stacked to hold the individual fibers between a groove on one plate and the flat surface of an adjacent plate. Alignment features, such as holes and pins, can facilitate plate alignment. The plates and fibers are secured in aligned position as by epoxy bonding, and the fiber ends are planarized, as by polishing. The assembly disclosed here is especially advantageous for mass termination of fiber optic cables and for interfacing to active devices.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 schematically illustrates a first embodiment of a stack-up assembly in accordance with the invention;

FIG. 2 is a perspective view of an advantageous form of the FIG. 1 embodiment;

FIG. 2A is an exploded view of the FIG. 2 assembly;

FIG. 3 is a perspective view of a mold set useful in making the ferrule plates used in the embodiment of FIG. 2;

FIG. 4 is an exploded view of a second form of the FIG. 1 embodiment;

FIG. 5 schematically illustrates a second embodiment of a stack-up assembly in accordance with the invention;

FIG. 5A is an exploded view of an advantageous form of the FIG. 5 embodiment; and

FIGS. 6, 6A, 6B and 6C are perspective views illustrating an advantageous way to make the ferrule plates used in the embodiment of FIG. 5A.

It is to be understood that the drawings are for the purpose of illustrating the concepts of the invention and are not to scale.

### DETAILED DESCRIPTION

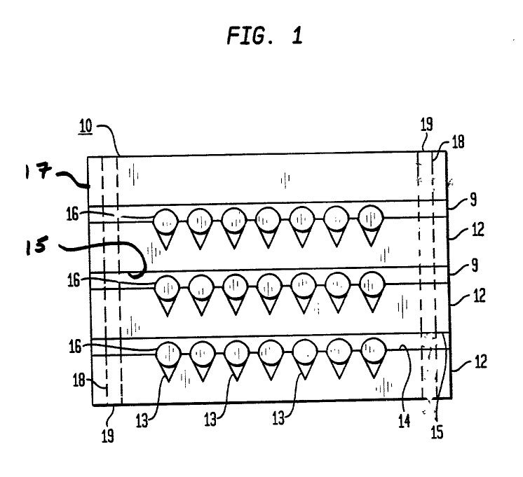

Referring to the drawings, FIG. 1 schematically illustrates a first embodiment of a stackup assembly 10 comprising a plurality of “single sided” ferrule plates 12. The term single sided here refers to the placement of a plurality of fiber aligning grooves 13 on only one side of each plate 12 in the stackup. In this embodiment, the grooves are V-grooves, and the plates are stacked with the V-groove side 14 of each plate adjacent to the flat side 15 of the next succeeding plate. Optical fibers 16 are disposed in the grooves 13 and retained within the grooves by adjacent flat surfaces 15 and appropriate bonding material, such as epoxy 9. The top plate in the stack 10 need not have grooves and can be a flat lid 17. Alternatively, the top plate could have grooves (not shown) on the top surface.

The plates 12 and lid 17 are stacked in vertical alignment with their grooves 13 aligned. Advantageously the edges are also aligned. Alignment can be facilitated by alignment holes 18 and alignment pins 19. The grooves 13 and the alignment holes 18, for each plate 12, are advantageously formed by the same molding surface so that alignment of the holes by the pins precisely aligns the grooves in the respective layers.

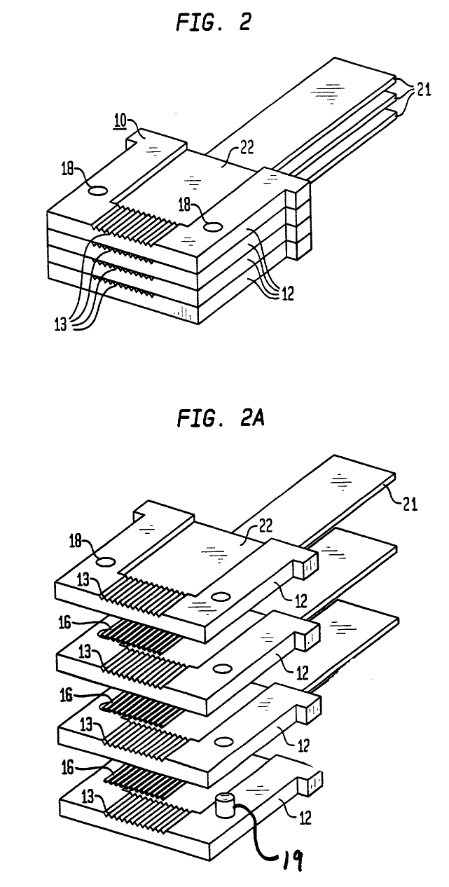

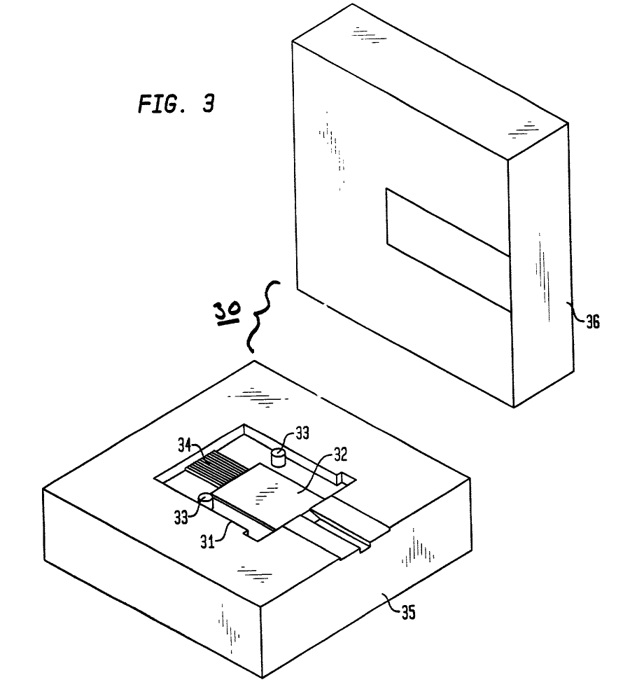

FIG. 2 illustrates an advantageous embodiment of such a stackup assembly. Fiber ribbons 21 enter between each pair of plates 12 in stackup assembly 10. Indentations 22 provide space for the unstripped portion of each fiber ribbon 21.

FIG. 2A is an expanded view of the FIG. 2 embodiment, with the plates 12 shown physically apart for insertion of individual fibers 16. Individual fibers 16 are stripped from the ribbon 21 and cleaved for location in the V grooves 13. Because the fibers are sandwiched between V grooves on one side and the flat surface on the other side, the fibers are aligned. Registration pins 19 (only partially shown in FIG. 2A) can be placed in precisely located pin holes 18 in each plate to facilitate vertical stacking and alignment of the plates, and the plurality of layers of optical fibers (shown here as three layers). After the stack assembly is complete, with optical fibers in the grooves and locked in place, fibers are polished against the plate edges in a plane typically normal to the fibers. This step completes the longitudinal registration of the fibers in the 2 D array.

An advantageous process for making the assembly of FIGS. 1 and 2 comprises molding the plurality of ferrule plates. In the molding step, a first molding surface moldingly engages the material to be molded to form the major surface 14 having grooves 13. The major flat surface 15 can be formed by molding with a second molding surface. Alternatively, the flat surface 15 can be preformed, as by machining, and only the grooved surface 14 need be molded. The first molding surface includes a molding pattern to form the grooves and to form registration features for the grooves.

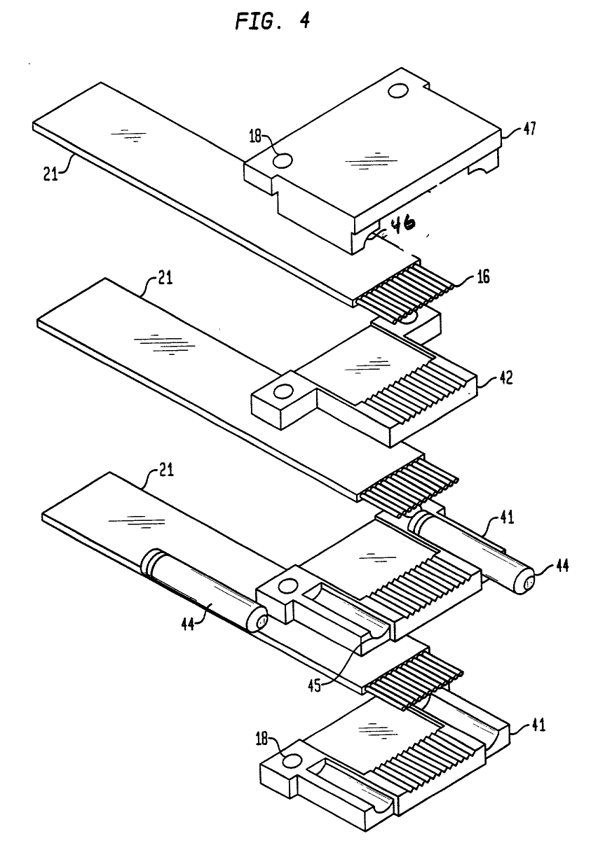

FIG. 3 shows a mold set 30 useful for making the ferrule plates 10 for the embodiment of FIG. 2. Mold set 30 is composed of mold cavity 35 and a mold core 36. Mold cavity 35 includes a molding surface 31 to mold features to form the edges of the ferrule plate, features 34 to form the grooves, features 32 to form the indentation for the unstripped portion of the fiber ribbon, and features 33 to form the alignment holes.

After providing a plurality of such plates, the assembly is then stacked by disposing optical fibers in the grooves of a plurality of plates and covering the grooved surfaces with the flat surfaces of respective neighboring plates. Finally, the plates and fibers are bonded into an aligned array, and a two dimensional array of fiber ends is formed from the fiber array, as by polishing.

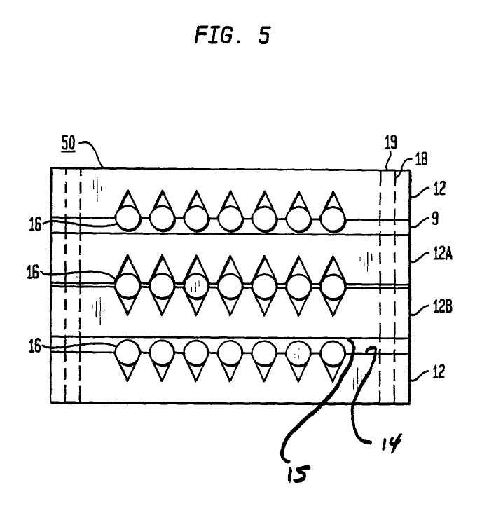

In a variation of the stackup assembly shown in FIG. 1, alternate layers of plates 12 can be made to different widths and connector pin holes and pins can be provided to facilitate lateral alignment with another stack up assembly. FIG. 4 shows such an assembly. Here, plates 41 are the standard full width, while plate 42 is narrower. This difference in width allows lateral connector pin 44 to contact lateral alignment grooves 45 on plate 41 and the surfaces 46 of lid 47 on alternate sides of narrow plate 42.

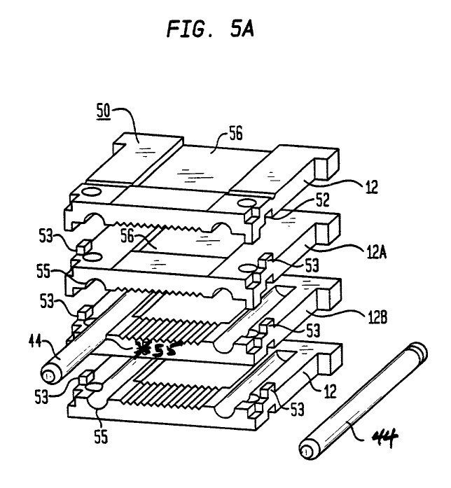

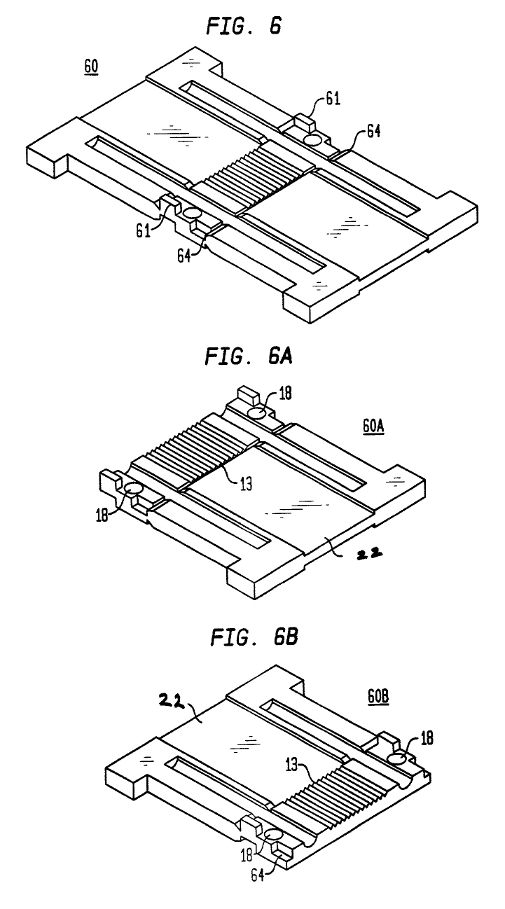

FIG. 5 schematically illustrates an alternative embodiment of a stackup assembly 50. In this embodiment, except for an interior pair (12A and 12B), the single-sided ferrule plates 12 are stacked with the groove side 14 of each on the flat side 15 of a succeeding plate. But at least one interior layer of fibers 16 is held in place by the opposing groove surfaces of plates 12A and 12B. Because the plates are single sided, the layers of the stackup on either side of the interior plates 12A, 12B rest on one flat surface, as discussed above.

FIG. 5A shows a preferred form of the FIG. 5 assembly including arrangements to achieve lateral alignment of the stackup 50 with another stackup (not shown) for use as a connector. Here, lateral alignment pins 44 can be fit into molded grooves 55 between the central pair of plates. Pins 44 project from the front face of the stack (serving as the plug of a connector pair) and may be inserted into corresponding holes in a stack serving as a connector jack (not shown). Indentations 56 are for receiving the unstripped portion of the fiber ribbons. Indentations 52 and matching projections 53 can facilitate alignment of successive plates and reinforce the joint.

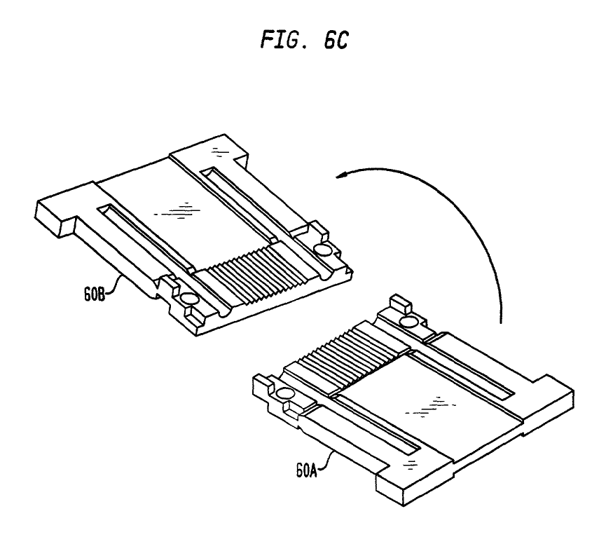

It is important to match all of the plates, including the grooves on interior plates 12A, 12B where the grooved sides face each other. Registering one set of grooves with the adjacent set can be facilitated by making the two plates from an extended symmetrical plate molded in the same form. FIG. 6 illustrates such an extended plate 60. Here, “extended” means that the molded piece 60 has extra material that can be cut or broken off to create either plate 60A as shown in FIG. 6A, or plate 60B, as shown in FIG. 6B. The grooves 13 and common set of alignment holes 18 are simultaneously molded into only one side of an extended piece 60 that can become either of two plates.

After molding, the top or bottom plate is created by separating (cutting or breaking) the extended piece 60 along the appropriate molded relief line 61 or 64. When making plate 60A, the extended piece is separated at relief line 61, and part 63 is discarded. When making plate 60B, the extended piece is separated at relief line 64, and part 65 is discarded. The two resulting plates have grooves 13 on one side and a flat surface on the other side, as before. Because the grooves 13 and corresponding alignment holes 18 are molded by the same molding surface and are common to both plates, registration can be held to a tight tolerance. FIG. 6C shows the orientation of plates 60A and 60B for final assembly.

It can now be seen that the invention relates to an assembly for stacking and retaining a plurality of optical fibers with their ends aligned in a two dimensional array. The assembly comprises a first plurality of ferrule plates, each ferrule plate having a pair of parallel major surfaces forming a pair of respective sides, one of the sides comprising a plurality of grooves for receiving optical fibers and the other side comprising a substantially flat surface. A plurality of optical fiber having terminated ends are disposed in the parallel grooves. The ferrule plates are stacked with the groove side of each ferrule plate adjacent a flat side of an adjacent plate locking the fibers within the grooves of the groove side. The stacked ferrule plates and fibers are secured to maintain alignment of the fiber ends, and the fiber ends are substantially aligned in a plane.

The invention may now be more clearly understood by the following specific example:

### EXAMPLE

A ferrule plate having nominal dimensions of 7 mm width by 7.5 mm length and 0.74 mm thickness is formed by molding, using either a thermoplastic or thermoset compound. To be suitable for this application, a compound requires the ability for precise feature replication and dimensional stability over time. An appropriate thermoplastic compound is a polyphenylene sulfide filled with mineral and/or glass particles, such as Fortron PPS 8670A61 from Ticona. The forming is done in a two-part, separable, hardened steel mold, where the features used to form the grooves and stacking alignment holes are fixed within one half of the mold.

A ferrule plate includes an array of 12 V-grooves 2.5 mm long spaced 0.250 mm apart. The approximately 70° included angle and 0.16 mm depth of each groove are sized such that the centerline of a 0.125 mm diameter fiber laying in the groove is approximately 53 μm below the ferrule plate's flat surface adjacent to the grooves. A second ferrule plate stacked with its flat surface contacting the fiber array will thus be spaced approximately 10 μm apart from the first plate's surface. A multiple-row stack thus positions the fiber rows 0.750 mm apart, and the fiber ends are thus aligned in a planar array of about 250 micrometers (0.250 millimeters)×750 micrometers (0.750 millimeters). The stack alignment holes are 0.7 mm in diameter and perpendicular to the major surfaces. Pins with a slight interference fit are pressed into them to keep the stack layers in accurate lateral registration. An epoxy, such as Epotek 353ND, is used to permanently bond the plates and fibers together, and the protruding fiber ends are polished smooth and flush with the flat ferrule end face.

It is understood that the above-described embodiments are illustrative of only a few of the many possible specific embodiments, which can represent applications of the invention. Numerous and varied other arrangements can be made by those skilled in the art without departing from the spirit and scope of the invention.

What is claimed is:

1. An assembly for stacking and retaining a plurality of optical fibers with their ends aligned in a two dimensional array, the assembly comprising:
an aligned stack of a plurality of ferrule plates, each ferrule plate having a pair of parallel major surfaces forming first and second respective sides, the first side comprising a plurality of grooves for receiving optical fibers, and the second side comprising a substantially flat surface, wherein a plurality of the ferrule plates are stacked with the first side adjacent to the second side of the adjacent plate and the optical fibers are disposed in the grooves and between first and second sides.

2. The assembly of claim 1 wherein at least one pair of the ferrule plates are stacked with their grooved sides adjacent and aligned for enclosing optical fibers between successive aligned grooves.

3. The assembly of claim 1 wherein the grooves on each grooved side are parallel.

4. The assembly of claim 1 wherein each ferrule plate is substantially identical.

5. The assembly of claim 1 wherein each ferrule plate includes holes to facilitate alignment of successive plates.

6. The assembly of claim 1 wherein each ferrule plate includes holes and pins inserted in the holes to facilitate stack alignment.

7. The assembly of claim 1 wherein the fiber grooves are essentially V shaped grooves having a maximum dimension in excess of about 0.16 mm in depth.

8. An optical fiber termination block comprising an assembly according to claim 1.

9. An optical fiber connector comprising an assembly according to claim 1.

10. The optical fiber connector of claim 1, further comprising lateral grooves and mating pins, said mating pins disposed in the lateral grooves for mated connector alignment.

11. The assembly of claim 1 wherein the fiber ends are aligned in a plane forming an array with center to center end spacing of about 250 μm.

12. The assembly of claim 1 wherein the fiber ends are aligned in a two dimensional planar array with center-to-center end spacing of about 250 μm×750 μm.

13. A method of making an assembly for stacking optical fibers with the fiber ends in an aligned two dimensional array comprising the steps of:
providing a plurality of ferrule plates, each plate having a pair of parallel major surfaces, one of the major surfaces having a plurality of grooves for receiving optical fibers and the other surface substantially flat;
stacking an array of optical fibers by disposing optical fibers in the grooves of a plurality of plates and covering the grooved surfaces with the flat surfaces of respective neighboring plates;
bonding the plates and fibers in an aligned array; and,
forming from the array of fibers an aligned two dimensional array of fiber ends.

14. The method of claim 13 wherein providing the plurality of ferrule plates comprises molding the plurality of grooves onto one major surface of each plate.

15. The method of claim 14 wherein providing the plurality of ferrule plates comprises molding the plurality of grooves onto one major surface and molding the flat surface on the other major surface of each plate.

16. The method of claim 14 wherein the molding of the plurality of grooves comprises contacting the material to be molded in molding engagement with a molding surface to form the grooves and to form alignment features in registration with the grooves.

17. The method of making an assembly for stacking optical fibers with the fiber ends in an aligned two dimensional array further comprising:
molding at least two extended symmetrical plates, each having a pair of parallel major surfaces, one of the major surfaces having a plurality of grooves for receiving optical fibers and the other surface substantially flat, each symmetrical plate having a first relief marking and a second relief marking;
separating one of the extended symmetrical plates at the first relief marking, making a first type ferrule plate;
separating another extended symmetrical plate at the second relief marking, making a second type ferrule plate;
disposing the optical fibers in the grooves of one of the ferrule plates; and,
assembling the first type of ferrule plate and the second type of ferrule plate with their grooved surfaces aligned.

18. The method of claim 17 wherein molding the symmetrical plate comprises molding alignment features in registration with the grooves.

19. The method of claim 18 wherein the alignment features are holes.
